(19) United States
(12) Patent Application Publication
(10) Pub. No.: US 2009/0319555 A1
(43) Pub. Date: Dec. 24, 2009

(54) OPTIMIZING DOCUMENTS BASED ON DESIRED CONTENT

(75) Inventors: ROBERT J. RAGNO, REDMOND, WA (US); EWA DOMINOWSKA, BELLEVUE, WA (US); MICK GUPTA, SAMMAMISH, WA (US); HRISHIKESH M. BAL, REDMOND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/145,056

(22) Filed: Jun. 24, 2008

(51) Int. Cl. G06F 17/30; G06F 7/06

(52) U.S. Cl. 707/102; 707/5; 707/E17.01; 707/E17.017

(57) ABSTRACT

Embodiments of the present invention relate to methods and computer storage media for optimizing the content of an online publisher. The content of the publisher is received. A category for each page of the publisher's content is determined. Desired content information and desired keyword information are received. A content deficiency of the publisher's content is determined based on at least one of the desired content or the desired keyword information. An optimization plan is created to improve the content deficiency of the publisher's content. The optimization plan is presented. In additional embodiments of the present invention, the layout of the publisher's content is analyzed and optimized. In an additional exemplary embodiment of the present invention, content modules are manipulated to optimize the publisher's content.

### BACKGROUND

Generally, publishers of online content have a difficult time optimizing their content to the trends in user demand or advertiser desire. The traditional notions of supply and demand also apply to the content provided by a publisher. Such that, when a publisher can supply content that is currently demanded, the publisher is rewarded by, among other things, increased user satisfaction of the publisher's content and increased revenue opportunities.

### SUMMARY

Embodiments of the present invention relate to methods and computer storage media for optimizing the content of an online publisher. The content of the publisher is received. A category for each page of the publisher's content is determined. Desired content information and desired keyword information is received. A content deficiency of the publisher's content is determined based on at least one of the desired content or the desired keyword information. An optimization plan is created to improve the content deficiency of the publisher's content. The optimization plan is presented.

This Summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWING

Embodiments are described in detail below with reference to the attached drawing figures, wherein:

FIG. 1 is a block diagram of an exemplary computing environment suitable for use in implementing embodiments of the present invention;

FIG. 2 is a block diagram illustrating an exemplary optimizer suitable for implementing embodiments of the present invention;

FIG. 3 is a block diagram illustrating the division of a presentation display, in accordance with an embodiment of the present invention;

FIG. 4 is a flow diagram of an exemplary method for optimizing a collection of internet accessible documents, in accordance with an embodiment of the present invention;

FIG. 5 is a flow diagram of an exemplary method for optimizing internet accessible documents based on a determined content deficiency, in accordance with an embodiment of the present invention; and

FIG. 6 is a flow diagram of an exemplary method for optimizing a collection of documents, in accordance with an embodiment of the present invention.

### DETAILED DESCRIPTION OF THE INVENTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Embodiments of the present invention relate to methods and computer storage media for optimizing the content of an online publisher. The content of the publisher is received. A category for each page of the publisher's content is determined. Desired content information and desired keyword information is received. A content deficiency of the publisher's content is determined based on at least one of the desired content or the desired keyword information. An optimization plan is created to improve the content deficiency of the publisher's content. The optimization plan is presented. In additional embodiments of the present invention, the layout of the publisher's content is analyzed and optimized. In an additional exemplary embodiment of the present invention, content modules are manipulated to optimize the publisher's content.

Accordingly, in one aspect, the present invention provides computer-storage media having computer-executable instructions embodied thereon for performing a method of optimizing a collection of internet accessible documents. The method includes receiving content of each page in the collection of documents. The method includes determining a category for each page of the collection of documents, receiving desired content information, and receiving desired keyword information. The method additionally includes determining a content deficiency in the collection of documents. The content deficiency is determined utilizing at least one of the desired content information and desired keyword information. The method includes creating an optimization plan for the collection of documents to improve the content deficiency utilizing the content deficiency, the content, and the category. The method also includes presenting the optimization plan.

In another aspect, the present invention provides a method for optimizing one or more internet accessible documents based on a determined content deficiency. The method includes receiving content of the one or more documents, receiving user desired content, and receiving advertiser desired keywords. The method additionally includes analyzing the content, the user desired content, and the advertiser desired keywords to determine the content deficiency. The content deficiency represents a discrepancy between the content and at least one of the user desired content and the advertiser desired keywords. The method also includes creating an optimization plan for the one or more documents. The optimization plan utilizes the content deficiency to optimize content of the one or more documents. The method further includes presenting the optimization plan.

A third aspect of the present invention provides computer-storage media having computer-executable instructions embodied thereon for performing a method of optimizing a collection of documents. The method includes receiving content of the collection of documents. The content includes keywords. The method includes determining a category of the collection of documents. The category is determined from the content. The category is selected from a set of predetermined topic categories. The method further includes receiving a navigation history of the collection of documents. The navigation history includes information on the navigation history of the collection of documents by one or more users. The method additionally includes receiving desired content information. The desired content information is determined from one or more search query logs. The method also includes receiving desired keyword information. The desired keyword information is determined from one or more keyword bidding logs that include information on one or more keywords bid on by one or more advertisers. The method further includes determining a content deficiency in the collection of documents, wherein the content deficiency is determined by comparing the content to: the desired content information to determine what desired content—as indicated by the desired content information—is not included in the plurality of documents, the desired keyword information to determine what desired keywords —as indicated by the desired keyword information—is not included in the plurality of documents, and the navigation history to determine a layout—as indicated by a predefined set of layout rules—that will increase user navigation of the content. The method additionally includes developing an optimization plan for the collection of documents utilizing the content deficiency. The optimization plan includes a listing of one or more categories, a listing of one or more phrases, a listing of one or more layout alterations to be incorporated with the plurality of documents, and presenting the optimization plan.

Having briefly described an overview of embodiments of the present invention, an exemplary operating environment suitable for implementing embodiments hereof is described below.

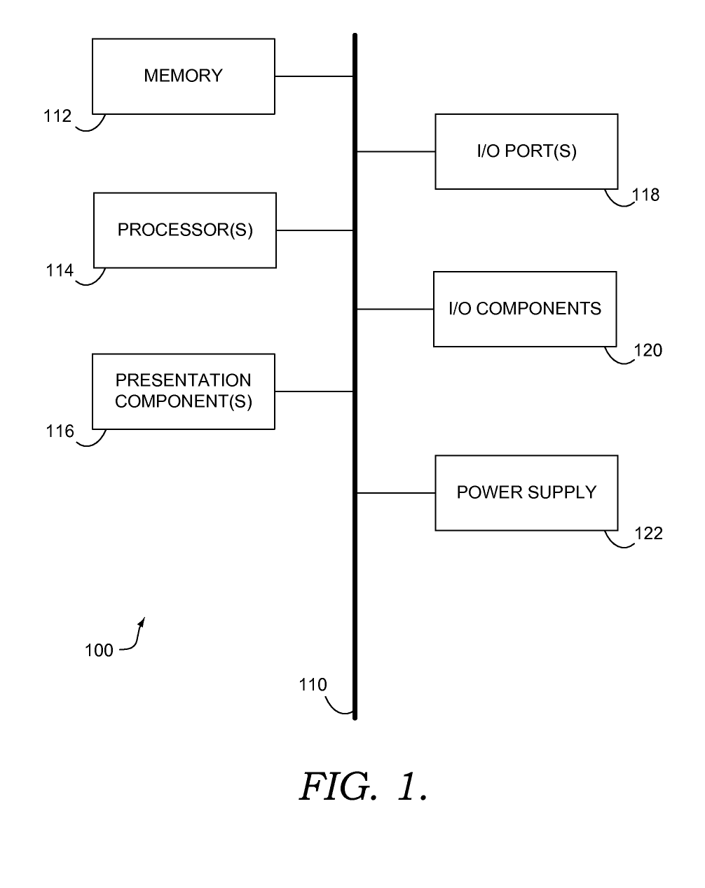

Referring to the drawings in general, and initially to FIG. 1 in particular, an exemplary operating environment suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

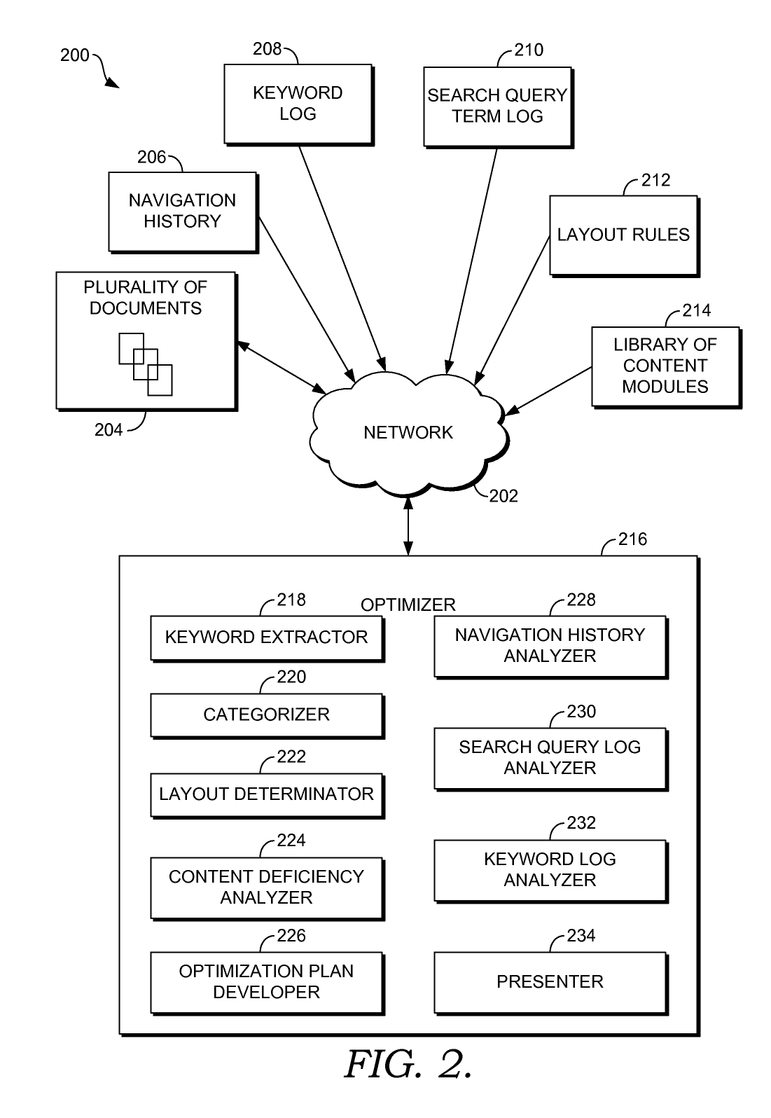

With reference to FIG. 2, an exemplary system suitable for implementing embodiments of the present invention is shown and designated generally as content optimizing system 200. The content optimizing system 200 includes a network 202 that is utilized to communicate a plurality of documents 204, a navigation history 206, a keyword log 208, a search query term log 210, layout rules 212, and a library content module 214 with an optimizer 216. The network 202 may include, without limitation, one or more local area networks (LANs) and/or wide area networks (WANs). Such networking environments are commonplace in offices, enterprise-wide computer networks, intranets, and the internet. Accordingly, the network 202 is not further described herein.

The optimizer 216 includes a keyword extractor 218, a categorizer 220, a layout determinator 222, a content deficiency analyzer 224, an optimization plan developer 226, a navigation history analyzer 228, a search query log analyzer 230, a keyword log analyzer 232, and a presenter 234. In an exemplary embodiment of the present invention, optimizer 216 is a computing device, such as computing device 100 discussed with reference to FIG. 1.

A document (also referred to as a page) of the plurality of documents 204 includes information managed by a publisher and consumed by a user. For example, the document may include internet accessible documents, web pages, blogs, wikis, electronic commerce pages, papers, articles, advertisements, and messages. In an exemplary embodiment of the present invention, the plurality of documents 204 is a collection of internet accessible web pages that are related by way of a common controlling entity, such as a publisher. The publisher is an entity that is able to modify, control, edit, and/or alter the documents. For example, an internet based content provider, such as a news service, publishes a number of documents that are presented to an audience of users. The news service may not be the creator of the documents that are published, but as a publisher, the news service is able to control the presentation and content of the documents. The document may include textual elements, multimedia elements, navigational elements, and advertising elements. The textual elements of the document provide the information or content of the document, such as the body of a news story or the review of a product. The multimedia elements include graphical elements, audio elements, and video elements. The navigational elements include hyperlinks, uniform resource locators, addresses, and other navigation components that allow a user to traverse multiple related documents. Advertising elements include advertisements that are related to the context of the document, and advertisements that are not related to the context of the document. The advertisement may include various elements previously described such as multimedia elements, textual elements, and navigational elements. Advertising elements traditionally produce revenue for the publisher of the document through either the mere display or the utilization of the advertisement. Collectively, the previously discussed elements are also referred to as content elements or just as elements.

In an exemplary embodiment of the present invention, the plurality of documents 204 are a collection of documents published by a common entity, such that optimization of several of the individual documents of the plurality of documents 204 result in a greater net effect on the plurality of documents 204 than the sum effect on each of the documents individually. For example, the changes that optimize a first document result in an optimization of a second and third document of the plurality of documents 204 because of their relationship through a common publisher. In an additional exemplary embodiment of the present invention, the plurality of documents 204 include at least one document that is not yet publicly accessible. For example, a publisher may have an option between multiple content elements that could populate a document, but the ability to provide those alternative options to the present invention will allow the publisher to determine which of the content elements should be published before actually having to publish the documents. This allows the present invention, in an exemplary embodiment, to serve as a proactive tool in optimizing documents of the plurality of documents 204.

Navigation history 206 is a history of the user navigation of at least one of the plurality of documents 204. In an exemplary embodiment of the present invention, the navigation history 206 is a recorded history that indicates a user's browse path as a user navigates and manipulates a particular document. For example, a document that contains textual, multimedia, and advertising elements allows a user to view and utilize each of those elements for their intended purpose, the navigation history 206 is a log of how the user travels to and from each element of the document.

Navigation history 206, in an exemplary embodiment of the present invention, is a navigation log of the plurality of documents 204. The navigation log is maintained on a server that serves the plurality of documents 204. Additionally, the navigation history 206 provides a navigational history for a collection of documents as opposed to a single document of the plurality of documents 204. Therefore, navigation history 206 includes a history of the navigation within and among the various documents of the plurality of documents 204 covered by the navigation history 206. In an exemplary embodiment of the present invention, navigation history 206 is a publisher provided navigation log. The publisher of the plurality of documents 204 will have access to a log that includes a reporting of user activity within the plurality of documents 204.

In an additional exemplary embodiment of the present invention, navigation history 206 is a user provided navigation log from a user of the plurality of documents 204. For example, a user or the user's computing device maintains a log of the user's activity within the plurality of documents 204. The log is then provided to report the user's navigation history of the plurality of documents 204. A user may provide the navigation log as part of a bargain where the user is granted additional resources, services, or other benefits in return for providing information relating to the user's navigation of the plurality of documents 204.

In yet an additional exemplary embodiment of the present invention, navigation history 206 is a navigation log from an analytical program associated with the plurality of documents 204. The analytical program provides a way of tracking the user navigation of the plurality of documents 204. Two approaches to collecting analytical program data include log file analysis and page tagging. The first method, log file analysis, reads the log files in which a server of the plurality of documents 204 records all of the transactions related to the plurality of documents 204. The second method, page tagging, uses a script, such as JavaScript, on each page of the plurality of documents 204 to notify a third-party server when a page is rendered by a user's computing device, such as computing device 100 discussed previously with respect to FIG. 1.

Keyword log 208 is a record of keywords desired by advertisers. For example, keyword log 208 is a log of the keywords purchased by advertisers on an online advertisement system, such as keywords bid for by advertisers wishing to advertise through the Microsoft adCenter service available from Microsoft Corporation of Redmond, Wash. A record that indicates which keywords (key phrases) advertisers desire is compiled as a keyword log 208. The keyword log 208 provides a listing of the desired keywords. In an exemplary embodiment of the present application, the keyword log 208 additionally includes a metric that describes the desirability of the keywords. For example, the metric may describe the number of different advertisers that bid on a particular keyword, the amount of money bid on a particular keyword, and a keyword purchase pattern and/or the frequency of the bidding on a particular keyword. The more advertisers that bid on a particular keyword may indicate that the particular keyword is desirable to the advertisers. Additionally, it may indicate that the same particular keyword is desirable to the publishers and even the users of the content where the advertisement will eventually be presented. A keyword purchase pattern provides information relating to trends in the purchasing of keywords. For example, a particular keyword that was not highly desirable during a previous sampling period, but now is more desired, would indicate a pattern of increased user activity surrounding that particular keyword. This trend may be extrapolated over an extended period of time to provide an indication of the trending of that particular keyword.

Search query term log 210 is a record of search query terms that have been utilized in a query. For example, a search query term log 210 may include the log of search terms (search phrases) entered as search queries in an online search engine. In an exemplary embodiment of the present invention, a search engine maintains a record of the search query terms that are utilized to conduct search queries. The record of the search query terms is presented as a search query term log 210. In an additional exemplary embodiment of the present invention, the search query term log 210 includes the frequency of the search query terms to provide an indication of the desirability of each of the search query terms.

Layout rules 212 provide one or more predefined rules for organizing the content elements of a document. The layout rules 212 are utilized when optimizing the layout of a document. The layout rules 212, in an exemplary embodiment of the present invention, provide a relative location that content elements of the document should be located to one another. For example, the layout rules 212 may indicate that an advertising element should be positioned above a textual element on the document.

The library of content modules 214 is a collection of multiple content modules. A content module is an interchangeable component that may be inserted as the content onto a document. For example, a document may be a blank page that provides a variety of locations that can be populated with one or more content modules. Once a content module is inserted into the document, the document appears to be the source of the content, but in actuality the combination of the content modules are the sources of the content. Therefore, the content modules may be manipulated to change the content of the document without having to manipulate the document. Yet, the document may be manipulated to change the location of the various content modules without affecting the content of the content modules. This modular system allows a document to be customized for each individual user that desires different content. In such a circumstance, the document can be optimized by altering the type of content modules or location of the content modules.

In an exemplary embodiment of the present invention, optimizer 216 optimizes one or more of the plurality of documents 204 based on one or more of the navigation history 206, the keyword log 208, the search query term log 210, the layout rules 212, and/or the library of content modules 214.

Keyword extractor 218 extracts keywords from the plurality of documents 204. In an exemplary embodiment of the present invention, keyword extractor 218 crawls the plurality of documents 204 to identify keywords. Keywords are words or phrases that a user would expect to be relevant to the associated document. Categorizer 220 categorizes the plurality of documents 204 into a variety of categories. In an exemplary embodiment of the present invention, categorizer 220 categorizes each document of the plurality of documents 204 into at least one category. In an alternative embodiment, categorizer 220 categorizes the entire plurality of documents 204 into at least one category. A category is a topic of the document or plurality of documents that are categorized. In an exemplary embodiment of the present invention, categorizer 220 utilizes a categorizing system that is known by those having ordinary skill in the art, such as an SBM system.

The layout determinator 222 determines the layout of the plurality of documents 204. The layout of a document is the location of the various content elements of the document relative to one another. For example, the layout of a document includes identifying the position of a multimedia element relative to an advertising element. The location of these content elements within a page determines the layout of the page. Therefore, the layout determinator 222 identifies the position or location of the various content elements that comprises a document. Additionally, the layout determinator 222 determines the location and style of the various content elements of the document, such as the location and style of the navigational elements. The layout determinator 222 may also determine if related content is divided among multiple documents. For example, a news story may be divided into multiple parts, with each part located on a different page to provide more locations for advertising elements to be displayed.

The navigation history analyzer 228 analyzes the navigation history 206 to determine user browse path information. For example, user browse path information includes how the user got to a particular document, how long the user stayed at a particular document, the frequency of links and elements utilized on the document, the length of time to utilize the elements of the document (how long to click on a link within the document), and the number of documents within the plurality of documents 204 the user visited or utilized. The browse path information is utilized to generate a metric that measures the user interest, the user satisfaction, and the user attention to the plurality of documents 204.

The search query log analyzer 230 analyzes the search query term log 210. The analysis identifies topics (categories) that are in demand by users. For example, search query term log 210 is provided from a search engine with a plurality of users that utilize the search engine to locate documents on the internet based on a search query. The search queries indicate content that is desirable to the plurality of users. The search query log analyzer 230 analyzes the search query term log 210 to identify the topics that are desired by the users. In an exemplary embodiment of the present invention, the desired topics are determined by breaking down the search queries indicated in the search query term log 210 into a variety of topics. Additionally, the volatility of the topics are determined in an exemplary embodiment. In one embodiment, volatility of a topic is determined by monitoring the desirability of a specific topic over a period of time. If the desirability of a topic changes significantly over a predefined period of time, then the topic is considered volatile. But, if the topic maintains a relatively stable level of desirability, then the topic is not volatile.

The keyword log analyzer 232 analyzes the keyword log 208. Analysis of the keyword log 208 includes evaluating the keywords included in the log to identify the variety of topics the keywords cover. In an exemplary embodiment of the present invention, the functionality of the categorizer 220 is implemented by the keyword log analyzer 232 to identify the topics included in the keyword log 208. For example, the keyword log 208 includes keywords that advertisers desire, as evidenced by the advertiser bidding on the keyword. A topic is determined for each of the keywords to identify topics that are desirable to the advertisers. Therefore, the topics that are desired by the advertisers are determined by categorizing the purchased keywords into a variety of topics.

The optimization plan developer 226 develops an optimization plan for the plurality of documents 204. In particular, the optimization plan developer 226 utilizes one or more of the navigation history 206, the keyword log 208, the search query term log 210, and the layout rules 212 to develop the optimization plan. An optimization plan optimizes at least one document of the plurality of documents. An optimization plan is a suggested or automatic change to at least one of the plurality of documents 204. Optimization includes, but is not limited to the increase of user satisfaction, increase of user time at the optimized documents, increase of revenue (long-term and short-term revenue), and increase of relevance of the optimized documents. Optimization includes, in part, prioritizing and/or ranking a list of content elements selecting content elments based on topics and/or categories, removing and/or replacing content elements, and altering the aesthetic appearance of the content elements for presentation. In an exemplary embodiment of the present invention, the optimization plan presents a list of topics that should be included in the content of the optimized documents. For example, the optimization plan developer 226 will automatically generate a list of topics or categories that are absent or under represented in the plurality of documents 204. The list of topics will include one or more topics that are suggested categories of content to be added to the plurality of documents 204 in order to optimize the plurality of documents 204.

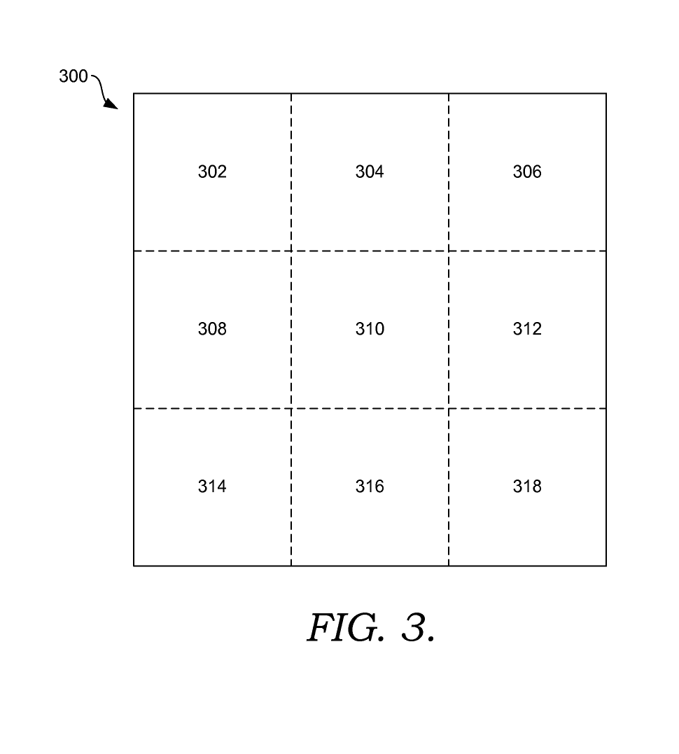

The optimization plan developer 226 will utilize the analysis of the navigation history analyzer 228, the search query log analyzer 230, and the keyword log analyzer 232 to develop an optimization plan for the plurality of documents 204. Examples of optimization plans include utilizing the analysis of the navigation history analyzer 228 to optimize the user's browse path. This may be accomplished by moving elements of the plurality of documents 204 to different locations. The locations for the elements, in an exemplary embodiment of the present invention, are guided by the layout rules 212. For example, turning to FIG. 3, a depiction of a division of a presentation display 300. Presentation display 300 includes nine sections identified by the numerals 302-318. Each of the nine sections of the presentation display 300 identifies a location where elements may be located. For example, section 304 is the upper-center section of the nine sections. The layout rules 212 provide rules for positioning elements of a document. A rule of the layout rules 212, in an exemplary embodiment, dictates that an advertising element must be positioned within section 304 so that the advertising element is located in the top center of the document. This may be a result of a determination that elements within section 304 receive the greatest user attention as evidenced by the analysis of the navigation history analyzer 228.

An additional example of an optimization plan is created from a gap analysis. A gap analysis identifies a discrepancy that exists between the content of the plurality of documents 204 and the identified topics from either the search query log analyzer 230 or the keyword log analyzer 232. For example, the keyword extractor 218 extracts the keywords from the plurality of documents 204. The extracted keywords are utilized by the categorizer 220 to identify the topics associated with the plurality of documents 204. The content deficiency analyzer 224 compares the identified topics of the plurality of documents 204 with either the desired content of the publishers (as evidenced by the keyword log analyzer 232) or the desired content of the users (as evidenced by the search query log analyzer 230). If, for example, the search query log analyzer 230 determines that content relating to a new video gaming system is desirable based on the number of search queries submitted by users, but the plurality of documents 204 fails to include sufficient or any content covering the topic of the new gaming system, then the content deficiency analyzer 224 will determine that the new gaming system content is deficient from the plurality of documents 204. In an exemplary embodiment of the present invention, the optimization plan developer 226 will utilize the output of the content deficiency analyzer 224 to develop the optimization plan. Continuing with the above gaming system example, when it has been determined that a content deficiency exists in the plurality of documents 204, the optimization plan developer 226 will automatically generate an optimization plan that provides, among other things, a suggestion to include content relating to the new gaming system on one or more of the plurality of documents 204.

In an additional exemplary embodiment of the present invention, the content deficiency analyzer 224 compares the topics of the plurality of documents 204 to the topics desired by the advertisers as indicated by the analysis of the keyword log analyzer 232. The content deficiency analyzer 224 will perform a gap analysis to determine that the desired content of the advertisers is not adequately covered by the plurality of documents 204. This analysis is utilized by the optimization plan developer 226 to develop an optimization plan that includes suggesting the addition of the deficient content or the inclusion of one or more keywords within the existing content to make the existing content more relevant.

In an exemplary embodiment of the present invention, the optimization plan developer 226 develops an optimization plan that utilizes the library of content modules 214. For example, if the content deficiency analyzer 224 determines that content is deficient from a document, the optimization plan indicates that a specific content module that includes the deficient content should be automatically inserted into the document. Stated as an example, if the document is a gaming system home page and the library of content modules 214 includes a plurality of articles relating to games available for the gaming system, the optimization plan will request an article that discusses the most desirable game to be displayed on the document. As a result of the inclusion of the content module that fills the identified content gap, the document now satisfies the user's and/or the advertiser's need for desired content.

The presenter 234 presents the optimization plan developed by the optimization plan developer 226. For example, when the optimization plan is presented to the publisher of the plurality of documents 204, the presenter 234 includes a presentation module 116 as discussed with reference to FIG. 1. In an additional exemplary embodiment of the present invention, the presenter 234 presents the optimization plan to an enabler that automatically adjusts the elements of the plurality of documents 204 to enable the optimization plan. For example, when the optimization plan includes an optimization of content modules, the presenter 234 automatically provides the optimization plan to allow for the optimization plan to be enacted without human intervention. In an additional embodiment of the present invention, the presenter 234 includes a computing device's screen, a projector, a printer, a computer storage media, and an electronic communication that is interpretable by a human.

It is understood and appreciated by those with ordinary skill in the art that the components, devices, and modules visually depicted as part of optimizer 216 are merely an exemplary embodiment of the present invention. The visual depiction of the various components, devices, and modules does not limit the scope of the present invention. Nor should there be inferred a dependency that all or any of the components, devices, and modules are included in the present invention. Instead, it is understood by those with ordinary skill in the art that any and all combinations of the components, devices, and modules are contemplated as well as how they are coupled to one another.

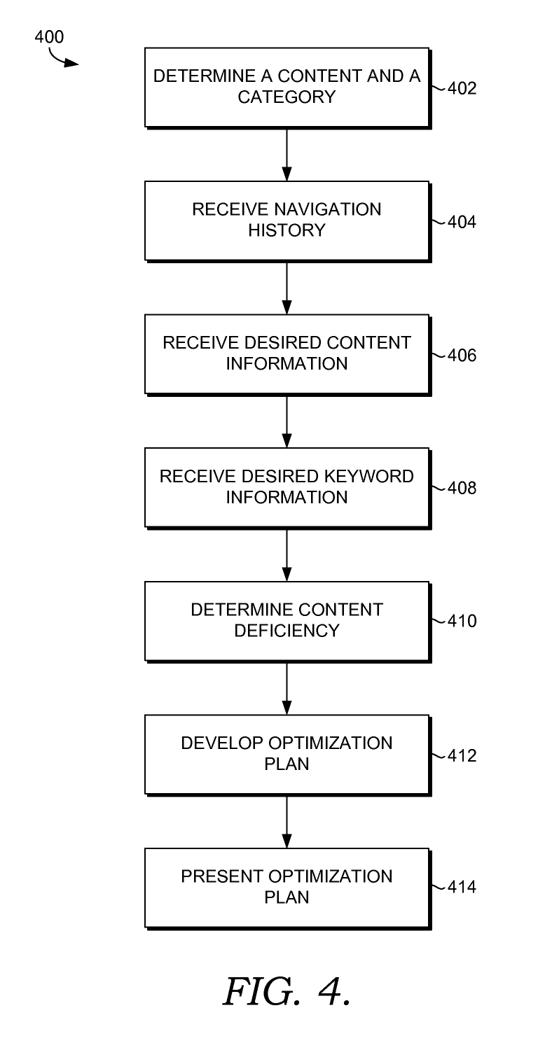

Turning now to FIG. 4, a flow diagram illustrates an embodiment of a method 400 for optimizing a collection of internet accessible documents. Represented at a block 402 the optimizer 216 determines a content and a category of the plurality of documents 204. As previously discussed, the determination of the content includes identifying keywords (phrases) of the plurality of documents 204. Additionally, the determination of a category includes determining one or more categories that apply to each or all of the plurality of documents 204. For example, a first document of the plurality of documents 204 may be categorized by the following topics: “entertainment”, “video game”, and “XBOX” (available from the Microsoft Corporation of Redmond, Wash.). A second document of the plurality of documents 204 may be categorized as “news”, “economic news”, and “United States corporations”. This example shows that the document of the plurality of documents 204 may be categorized with multiple categories and the different documents of the plurality of documents are not required to share a common category even though they are from a common plurality of documents 204.

In an additional exemplary embodiment of the present invention, the content of the document is determined by evaluating the frequency of words included in the plurality of documents 204. For example, if a particular word is present above a threshold limit in the document, the particular word is determined to be relevant to the document and therefore useable to determine the content of the document. In an additional exemplary embodiment of the present invention, the category of the plurality of documents 204 is determined by identifying one or more topics from a predefined selection of topics based on the determined content of the document. For example, a number of topics that have been identified as possible document topics may be maintained in a list, and this listing of topics aids in the classification of the document categories such that a finite number of categories exist.

At a block 404, the optimizer 216 receives the navigation history 206. In an exemplary embodiment of the present invention, the navigation history 206 is received from a server that serves the plurality of documents 204. In an additional exemplary embodiment of the present invention, the navigation history 206 is received from a plurality of users that have provided access to their browse path histories. For example, a user that installs a toolbar into their internet browsing program may agree to allow the tool bar to communicate the user's browse history in return for the user's use of the toolbar.

At a block 406, the optimizer 216 receives the desired content information. In an exemplary embodiment of the present invention, the desired content information is the search query term log 210. The desired content information provides an indication of content that is desirable to one or more users. Desirability may be determined by ranking the search query terms of a search query term log 210 to determine those terms that were utilized a number of times above a predefined threshold. For example, desired content may be determined by identifying those search query terms that were the top 100 search terms for a specified period of time.

At a block 408, the optimizer 216 receives the desired keyword information. In an exemplary embodiment of the present invention, the desired keyword information is included in the keyword log 208. For example, the keyword log 208, in an exemplary embodiment, includes a listing of keywords purchased by advertisers of an online advertising system. The keywords purchased by advertisers indicates the desirability of those keywords and content associated with those keywords.

At a block 410, the optimizer 216 determines the content deficiency of the plurality of documents 204. The content deficiency is determined, in an exemplary embodiment, utilizing the previously determined content and category of step 402 and at least one of the desired content information and the desired keyword information. As previously discussed, a gap analysis is performed on the plurality of documents 204 to determine the deficiency between the content provided and the desired content as represented by either the desired content information of the users or the desired keyword information of the advertisers. The content deficiency represents a lack of a desired content in the plurality of documents 204.

At a step 412, the optimizer 216 develops an optimization plan for the plurality of documents 204. An optimization plan is a plan that identifies corrections for a determined content deficiency. For example, the optimization plan, in an exemplary embodiment of the present invention, provides one or more topics that should be included in the plurality of documents 204 in order to cure the determined content deficiency. The inclusion of the one or more suggested topics will fill a gap of content that is created by the user's desire for a particular content or an advertiser's desire for a particular content. The resulting optimization plan allows the publisher to provide content that fills a void in the desired content.

At a step 414, the optimizer 216 presents the optimization plan. For example, the presenter 234 of the optimizer will generate a report that provides the publisher with the optimization plan. In an additional exemplary embodiment, the presenter 234 will enable the publisher to automatically update the plurality of documents to reflect at least some of the proposals of the optimization plan. In another exemplary embodiment of the present invention, the presenter 234 provides the optimization plan to the publisher by way of a computing device utilized by the publisher.

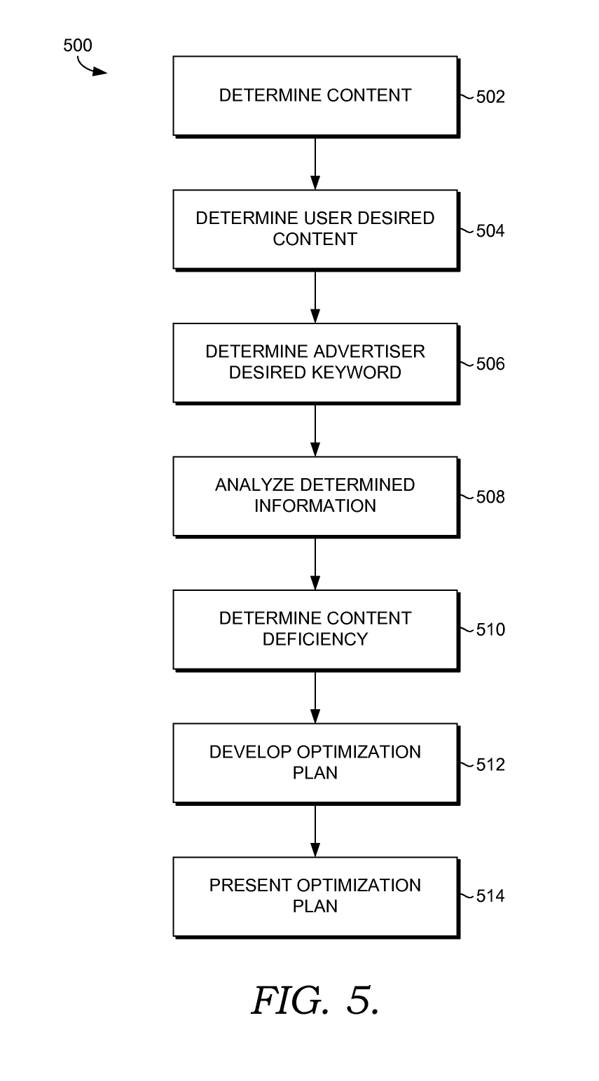

Turning now to FIG. 5, a flow diagram illustrates an embodiment of the method 500 for optimizing internet accessible documents based on a determined content deficiency. Referring to a block 502, the optimizer 216 determines the content of a plurality of documents 204. For example, the plurality of documents 204 are crawled by the optimizer 216 to identify the keywords of the plurality of documents 204. Once the keywords of the plurality of documents have been identified, the categories of the plurality of topics are determined from the identified keywords. In an additional exemplary embodiment of the present invention, the content of the plurality of documents 204 is determined utilizing previously determined content information of the plurality of documents 204. For example, if the plurality of documents 204 are indexed by a search engine, the search engine index is utilized to determine the content of the plurality of documents 204. Additionally, the content of the plurality of documents is received by the optimizer 216. The content, in an exemplary embodiment, is received from the publisher of the plurality of documents 204 for the optimization of the plurality of documents 204.

At a block 504, the optimizer 216 determines the user desired content. For example, the search query term log is received by the optimizer 216. Optimizer 216 then utilizes the search query log analyzer 230 to determine the user desired content from the search query log. At a block 506, the optimizer determines the advertiser desired keywords. In an exemplary embodiment, the advertiser desired keywords are determined from the keyword log 208 that was received by the optimizer 216. In an additional exemplary embodiment, the advertiser desired keywords are determined by analyzing the keyword purchase patterns, the number of advertisers associated with each keyword, or the amount an advertiser bids for each of the keywords. For example, a keyword purchase pattern represents the volatility of a particular keyword with respect to the frequency or value of the keyword.

At a step 508, the optimizer 216 analyzes the content of the plurality of documents 204 that was determined at block 502, the user desired content that was determined at block 504, and the advertiser desired keywords that were determined at block 506. The analysis of the information is utilized to determine a content deficiency, represented at a block 510. The content deficiency is a deficiency that exists between the determined content of the plurality of documents 204 and either the determined user desired content or the determined advertiser desired keywords. In an exemplary embodiment of the present invention, both the determined user desired content and the determined advertiser desired keywords are utilized at block 510 to determine the content deficiency of the plurality of documents 204.

At a block 512, the optimizer 216 develops an optimization plan. In an exemplary embodiment of the present invention, the optimization plan developer 226 develops the optimization plan utilizing the content deficiency determined at block 510. As previously discussed, the optimization plan includes optimizations that are automatically implemented upon being presented, or in the alternative the optimization plan includes optimizations that are enacted by the publisher.

At a block 514, the optimizer 216 presents the optimization plan. In an exemplary embodiment of the present application, the optimizer 216 employees the presenter 234 to present the optimization plan. The optimization plan is presented to the publisher of the plurality of documents 204. As previously discussed, the optimization plan may include suggestions that may be implemented to at least one of the documents of the plurality of documents 204. The suggestions may be directed to the layout of the plurality of documents to improve the location of the various elements of each of the documents. For example, textual elements may be moved to a more prominent location as defined by the layout rules 212 in order to increase user satisfaction of the document. In an additional embodiment, the optimization plan presented to the publisher may include a listing of keywords that should be incorporated into the plurality of documents 204 to provide a document that is desired by advertisers and therefore a potential source of income for the publisher.

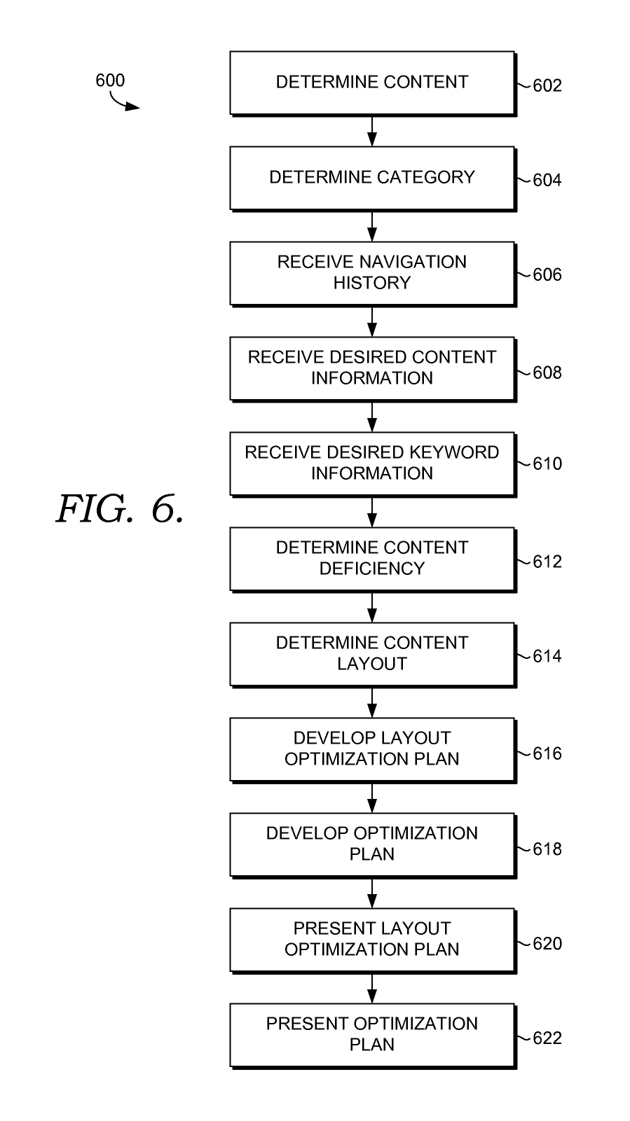

Turning now to FIG. 6, a flow diagram illustrates an embodiment of the method 600 for optimizing a collection of documents. At a block 602, the optimizer 216 determines the content of the plurality of documents 204. The plurality of documents 204, in an exemplary embodiment, were received by the optimizer 216 in order for the content to be determined. In an additional exemplary embodiment of the present invention the content of the plurality of documents 204 is retrieved from the plurality of documents to be utilized when determining what the content of the plurality of documents includes. The content of the plurality of documents 204 is determined by identifying the content of the plurality of documents 204 that are keywords.

At a block 604, the optimizer 216 determines the category of the plurality of documents 204. The category may include multiple categories for each document of the plurality of documents 204. A category is a topic or collection of topics that, in an exemplary embodiment, are from a predefined set of categories. The predefined set of categories provides a finite number of categories to select from when determining the category of the plurality of documents. A finite set of categories ensures that resources are utilized in an efficient manner when optimizing a plurality of documents 204.

At a block 606, the optimizer 216 receives a navigation history. In an exemplary embodiment of the present invention, the navigation history 206 is received by the optimizer 216 to indicate the user browse path information relating to the plurality of documents 204. In an exemplary embodiment, the optimizer employees the navigation history analyzer 228 in order to extract user browse path information that will be utilized in developing an optimization plan.

At a block 608, the optimizer 216 receives desired content information, such as search query term log 210. The desired content information provides an indication of content that is desired by users (audience) of the plurality of documents 204. Referring to a block 610, optimizer 216 receives desired keyword information. The desired keyword information, in an exemplary embodiment is provided by an online advertising system that maintains a record of the keywords purchased by advertisers utilizing the advertising system. The desired keyword information provides an indication of the keywords desired by one or more advertisers.

At a block 612, optimizer 216 determines a content deficiency of the plurality of documents 204. The content deficiency is determined utilizing the category and content of the plurality of documents 204 viewed in light of the determined desired content and desired keyword information. A gap analysis provides an indication of those keywords or content that is missing from the plurality of documents 204. The inclusion of those keywords and content that are determined lacking from the plurality of documents 206 would ultimately benefit the publisher through positive benefits to users or economic gains from advertisers.

At a block 614, the optimizer determines the content layout of the plurality of documents 204. For example, the layout determinator 222 is employed by the optimizer 216 to identify the layout of the elements of the plurality of documents 204. Additionally, the layout determinator 222 may indicate the relationship of the elements of the plurality of documents 204 among each of the documents. For example, if a news article is divided among several of the plurality of documents 204, the layout determinator 222 will identify that multiple documents are utilized to provide a single news article.

At a block 616, the optimizer 216 develops a layout optimization plan. The layout optimization plan addresses layout issues identified by the optimizer 216 based on the layout determined by the layout determinator 222 and the predefined layout rules 212. At a block 618, the optimizer develops an optimization plan for the plurality of documents 204. As previously discussed the optimization plan may address content deficiencies relating to keywords that should be included or content that should be included in the content of the plurality of documents 204.

At a block 620, the optimizer 216 presents a layout optimization plan. As previously discussed, an optimization plan may address the layout of the plurality of documents 204. The optimization plan portion that addresses the layout of the plurality of document is referred to as the layout optimization plan. The layout optimization plan is presented in manners discussed with respect to the presentation of the optimization plan.

At a block 622, the optimizer 216 presents the optimization plan. As previously discussed, the optimization plan may be presented to the publisher of the plurality of documents 204, or the optimization plan may initiate automatic changes to the plurality of documents 204.

What is claimed is:

1. One or more computer-storage media having computer-executable instructions embodied thereon for performing a method of optimizing a collection of internet accessible documents, the method comprising:
receiving content of each page in the collection of documents;
determining a category for each page of the collection of documents;
receiving desired content information;
receiving desired keyword information;
determining a content deficiency in the collection of documents, wherein the content deficiency is determined utilizing at least one of the desired content information and desired keyword information;
creating an optimization plan for the collection of documents to improve the content deficiency utilizing the content deficiency, the content, and the category; and
presenting the optimization plan.

2. The media of claim 1, wherein the content of the collection of documents is determined by the frequency of words included in the collection of documents and the category is determined by identifying one or more topics from a predetermined selection of topics based on the content.

3. The media of claim 1, wherein the collection of documents includes at least one document that is not yet available to an intended audience.

4. The media of claim 1, wherein the desired content information is derived from a search query log and the desired keyword information is derived from a keyword bidding log.

5. The media of claim 1, wherein the content deficiency is determined by comparing the content of the collection of documents to the desired content information to determine what desired content, as indicated by the desired content information, is not included in the collection of documents.

6. The media of claim 1, wherein the content deficiency is determined by comparing the content of the collection of documents to the desired keyword information to determine what desired keywords, as indicated by the desired keyword information, are not included in the collection of documents.

7. The media of claim 1, wherein the optimization plan includes a listing of one or more categories to be included with the collection of documents.

8. The media of claim 1, wherein the optimization plan includes providing a listing of one or more phrases to be included with the collection of documents.

9. The media of claim 1 further comprising:
receiving a navigation history of the collection of documents;
determining a content layout of content elements of at least one member of the collection of documents, wherein the content layout indicates the relative position of the content elements on the member;
creating a layout optimization plan for the member utilizing the navigation history, the content layout, and a predefined set of layout rules, wherein the predefined set of layout rules prioritize layout positions for the content elements on the member; and
presenting the layout optimization plan.

10. The method of claim 9 wherein the navigation history is one of the following,
(1) a server log of the server serving the collection of documents,
(2) a publisher provided navigation log from a publisher that publishes the collection of documents,
(3) a user provided navigation log from a user of the collection of pages, and
(4) a navigation log from an analytical program associated with the collection of pages.

11. A method for optimizing one or more internet accessible documents based on a determined content deficiency, the method comprising:
receiving content of the one or more documents;
receiving user desired content;
receiving advertiser desired keywords;
analyzing the content, the user desired content, and the advertiser desired keywords to determine the content deficiency, wherein the content deficiency represents a discrepancy between the content and at least one of the user desired content and the advertiser desired keywords;
creating an optimization plan for the one or more documents, wherein the optimization plan utilizes the content deficiency to optimize content of the one or more documents; and
presenting the optimization plan.

12. The method of claim 11, wherein the content is determined based on keywords of the one or more internet accessible documents.

13. The method of claim 11, wherein the user desired content is determined by way of one or more search query logs.

14. The method of claim 11, wherein the advertiser desired keywords are determined by way of one or more advertiser keyword bid logs.

15. The method of claim 14, wherein the advertiser keyword bid logs include keyword purchase patterns, number of advertisers associated with each keyword, and bid amount associated with each keyword.

16. The method of claim 11 further comprising automatically changing the content based on the optimization plan.

17. The method of claim 11 further comprising automatically changing at least one member of the one or more documents to utilize a specified content module from a library of content modules, wherein the automatically changing the member with the specified content module is determined by the optimization plan.

18. The method of claim 11 further comprising:
creating a content layout of content elements of at least one member of the one or more documents, wherein the content layout indicates the relative position of the content elements on the member;
developing a layout optimization plan for the member utilizing the navigation history, the content layout, and a predefined set of layout rules, wherein the predefined set of layout rules prioritizes layout positions for the content elements on the member; and
presenting the layout optimization plan.

19. The method of claim 18, wherein the presenting automatically changes the content layout based on the layout optimization plan.

20. One or more computer-storage media having computer-executable instructions embodied thereon for performing a method of optimizing a collection of documents, the method comprising:
determining the content of the collection of documents, wherein the content includes keywords;
determining a category of the collection of documents, wherein the category is determined from the content, and the category is selected from a set of predetermined categories;
receiving navigation history of the collection of documents, wherein the navigation history includes information on the navigation history of the collection of documents by one or more users;
receiving desired content information, wherein the desired content information is determined from one or more search query logs;
receiving desired keyword information, wherein the desired keyword information is determined from one or more keyword bidding logs that include information on one or more keywords bid on by one or more advertisers;
determining a content deficiency in the collection of documents, wherein the content deficiency is determined by comparing the content to,
(1) the desired content information to determine what desired content, as indicated by the desired content information, is not included in the plurality of documents,
(2) the desired keyword information to determine what desired keywords, as indicated by the desired keyword information, are not included in the plurality of documents, and
(3) the navigation history to determine a layout, as indicated by a predefined set of layout rules, that will increase user navigation of the content;
developing an optimization plan for the collection of documents utilizing the content deficiency, wherein the optimization plan includes a listing of one or more categories, a listing of one or more phrases, and a listing of one or more layout alterations to be incorporated with the plurality of documents; and
presenting the optimization plan, such that the optimization plan automatically optimizes the collection of documents.
